(19) United States
(12) Patent Application Publication
(10) Pub. No.: US 2026/0252719 A1
(43) Pub. Date: Aug. 27, 2026

(54) COOPERATIVE PROCESSING SYSTEM, PROTECTED AREA AVAILABLE COMPUTER, PROGRAM, AND COOPERATIVE PROCESSING METHOD

(71) Applicant: NTT, Inc., Tokyo (JP)

(72) Inventors: Tetsuro TOKUNAGA, Musashino-shi, Tokyo (JP); Yoshihide NAKAGAWA, Musashino-shi, Tokyo (JP)

(21) Appl. No.: 18/870,980

(22) PCT Filed: Jun. 20, 2022
(86) PCT No.: PCT/JP2022/024483

§ 371 Date: Dec. 2, 2024

(51) Int. Cl. G06F 21/62

(52) U.S. Cl. CPC G06F 21/6218

(57) ABSTRACT

A cooperation processing system includes a protected area usable computer and a general computer. The protected area usable computer includes a storage memory that includes a protected area capable of protecting data in use and a normal area different from a corresponding protected area, a protected area using processing unit that executes protected area using processing processed in the protected area, a normal area using processing unit that executes normal area using processing processed in the normal area, and a cooperation processing unit that makes a request for processing of the service to the normal area using processing unit or the general computer. The normal area using processing unit requests the protected area using processing unit to execute the protected area using processing in a case where the protected area using processing is included in processing included in processing of the service. The general computer requests the protected area using processing unit to execute the protected area using processing via the cooperation processing unit in a case where the protected area using processing is included in the processing.

### DESCRIPTION

### Technical Field

The present invention relates to a cooperation processing system, a protected area usable computer, a program, and a cooperation processing method related to cooperation between a protected area usable computer including a protected area that is a memory area with limited access and a general computer.

### Background Art

As one of countermeasures against attacks on a computer environment, there is provided a function of a central processing unit (CPU) that sets a partial area of a storage area (main storage, memory) as a protected area and executes an operation (calculation processing, processing) in the protected area (see Non Patent Literature 1). Calculation processing in which the protected area can be accessed is restricted, and even an operating system (OS) cannot access the protected area. In the future, an increase in network services (services) using such a protected area is expected.

The size of a protected area has an upper limit depending on the CPU, and the protected area does not increase even if a storage area is added. Therefore, it is considered that even if a service use increases, it is possible to cope with the increase by configuring computers that can use the protected area (protected area usable computers) into a cluster configuration.

In providing a service, calculation processing using a protected area is a part of the entire processing, and calculation processing using a normal area that is a storage area other than the protected area is also executed. In general, it is assumed that, when a request for a service is received, calculation processing using a normal area is executed, and calculation processing using a protected area is executed as necessary.

### CITATION LIST

### Non Patent Literature

Non Patent Literature 1: Enhanced Security Features for Confidential Computing, [online], Intel, [Searched on June 3, 2022], the Internet <URL: https://cdrdv2.intel.com/v1/dl/getContent/723693>

### SUMMARY OF INVENTION

### Technical Problem

In order to provide a service, a protected area and a normal area of a size necessary for executing processing for providing the service are required. For example, in a case where the normal area is insufficient, service provision is impossible even if the protected area is sufficient.

The present invention has been made in view of such a background, and an object thereof is to enable efficient use of a memory in processing of providing a service using a protected area.

### Solution to Problem

In order to solve the above issue, a cooperation processing system according to the present invention is a cooperation processing system including a protected area usable computer and a general computer, in which the protected area usable computer includes a storage unit that includes a protected area capable of protecting data in use and a normal area different from a corresponding protected area, a protected area using processing unit that executes protected area using processing processed in the protected area, a normal area using processing unit that executes normal area using processing processed in the normal area, a service reception unit that receives a request for a service, and a cooperation processing unit that makes a request for processing of the service to the normal area using processing unit or the general computer, the general computer includes a cooperation unit that receives a request for processing of the service, executes normal area using processing in processing included in processing of a corresponding service, and returns a processing result, the normal area using processing unit makes a request to the protected area using processing unit and causes the protected area using processing unit to execute the protected area using processing in a case where the protected area using processing is included in processing included in processing of the service, and the cooperation unit makes a request to the cooperation processing unit and causes the protected area using processing unit to execute the protected area using processing in a case where the protected area using processing is included in processing included in processing of the service.

### Advantageous Effects of Invention

According to the present invention, efficient use of a memory in processing of providing a service using a protected area is enabled.

### BRIEF DESCRIPTION OF DRAWINGS

FIG. 1 is an overall configuration diagram of a cooperation processing system according to a first embodiment.

FIG. 2 is a functional block diagram of a protected area usable computer according to the first embodiment.

FIG. 3 is a data configuration diagram of a memory status database according to the first embodiment.

FIG. 4 is a data configuration diagram of memory use amount prediction data according to the first embodiment.

FIG. 5 is a data configuration diagram of a general computer database according to the first embodiment.

FIG. 6 is a data configuration diagram of a service processing management database according to the first embodiment.

FIG. 7 is a functional block diagram of a general computer according to the first embodiment.

FIG. 8 is a first flowchart of cooperation processing according to the first embodiment.

FIG. 9 is a second flowchart of the cooperation processing according to the first embodiment.

FIG. 10 is a data configuration diagram of a service processing management database according to a second embodiment.

FIG. 11 is a first sequence diagram for describing cooperation processing according to the second embodiment.

FIG. 12 is a second sequence diagram for describing the cooperation processing according to the second embodiment.

FIG. 13 is an overall configuration diagram of a cooperation processing system according to a third embodiment.

FIG. 14 is a functional block diagram of a cluster management server according to the third embodiment.

FIG. 15 is a functional block diagram of a cluster management server according to a fourth embodiment.

FIG. 16 is a data configuration diagram of a normal area using processing management database according to the fourth embodiment.

FIG. 17 is a sequence diagram for describing cooperation processing according to the fourth embodiment.

FIG. 18 is a hardware configuration diagram illustrating an example of a computer that implements functions of the protected area usable computer according to the above-described embodiments.

### DESCRIPTION OF EMBODIMENTS

### Outline of Cooperation Processing System

Hereinafter, a cooperation processing system in modes for carrying out the present invention (embodiments) will be described. The cooperation processing system includes a protected area usable computer that can use a protected area and a general computer that can use a normal area. Upon receiving a request for a service using a protected area, the protected area usable computer executes processing by itself in a case where there is a free space in a normal area necessary for the processing of the service. In a case where there is no free space in the normal area, the protected area usable computer executes processing using the protected area (protected area using processing) by itself, and makes a request for (gives a commission of) processing using the normal area (normal area using processing) to the general computer.

By adopting such a processing mode, a service can be provided even in a case where there is no sufficient free space in the normal area in the protected area usable computer.

Note that the general computer may include a protected area, but the following embodiments will be described assuming that the protected area of the general computer is not used.

### Configuration of Cooperation Processing System

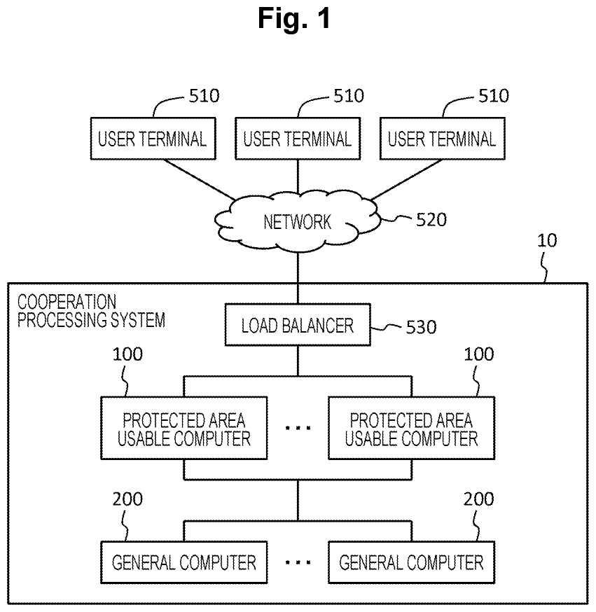

FIG. 1 is an overall configuration diagram of a cooperation processing system 10 according to a first embodiment. The cooperation processing system 10 includes a load balancer 530, one or more protected area usable computers 100, and one or more general computers 200. The load balancer 530 distributes a request for a service transmitted from a user terminal 510 via a network 520 to the protected area usable computers 100. Each of the protected area usable computers 100 and the general computers 200 forms a layer (first layer, second layer).

A requested service is processed using a protected area. More specifically, processing of executing a service includes a series of processing (calculation processing, operation), a part of the calculation processing is processed using a protected area (protected area using processing), and other calculation processing is processed using only a normal area without using a protected area (normal area using processing). For example, the processing of executing a service is processing that starts with normal area using processing, continues with protected area using processing, normal area using processing, and protected area using processing, and ends with normal area using processing.

### Configuration of Protected Area Usable Computer

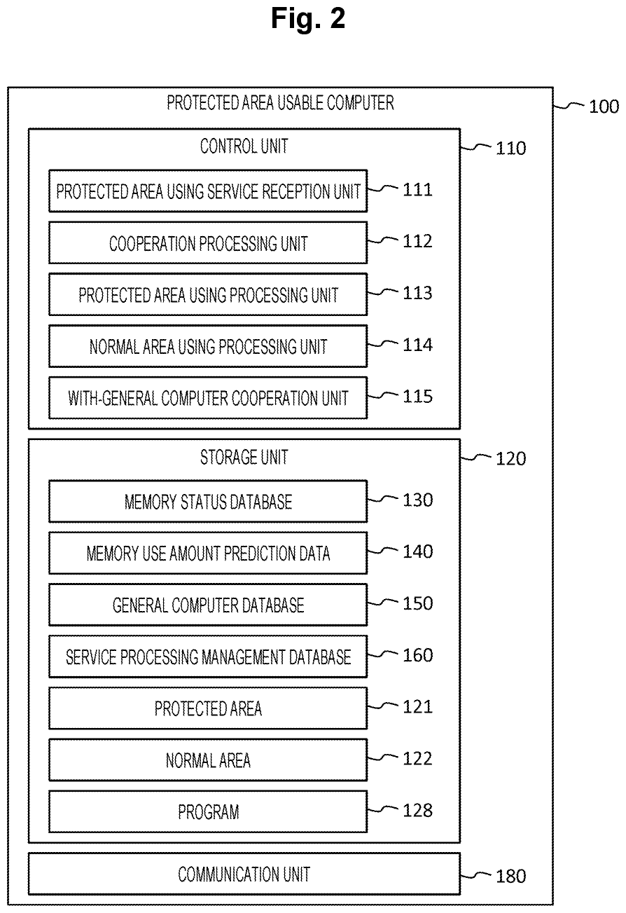

FIG. 2 is a functional block diagram of the protected area usable computer 100 according to the first embodiment. The protected area usable computer 100 includes a control unit 110, a storage unit 120, and a communication unit 180. The communication unit 180 includes a communication device, and transmits and receives communication data to and from the load balancer 530 and the general computers 200.

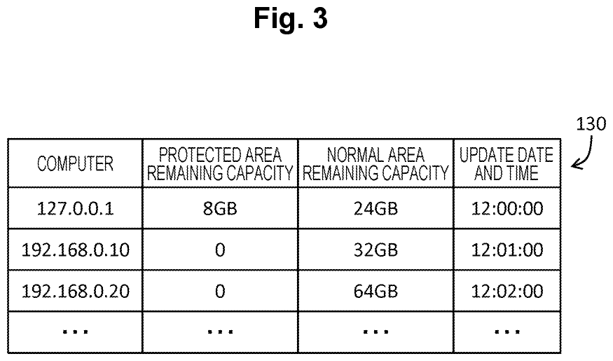

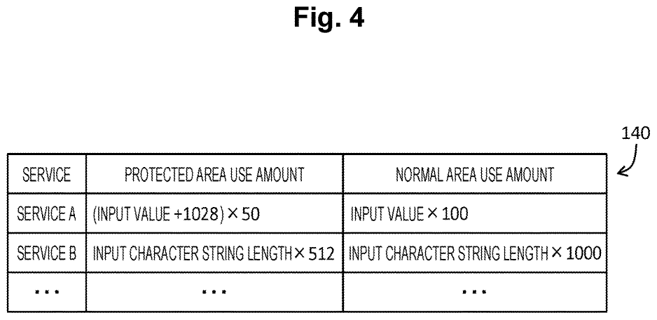

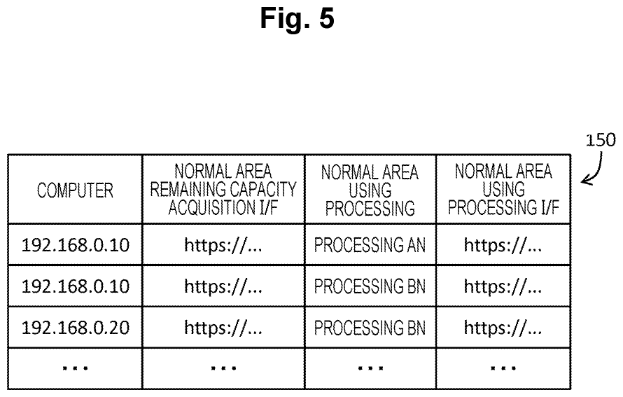

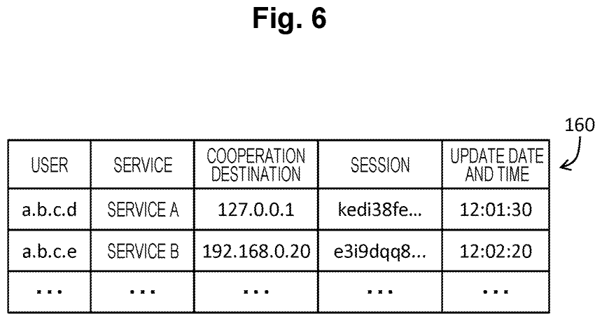

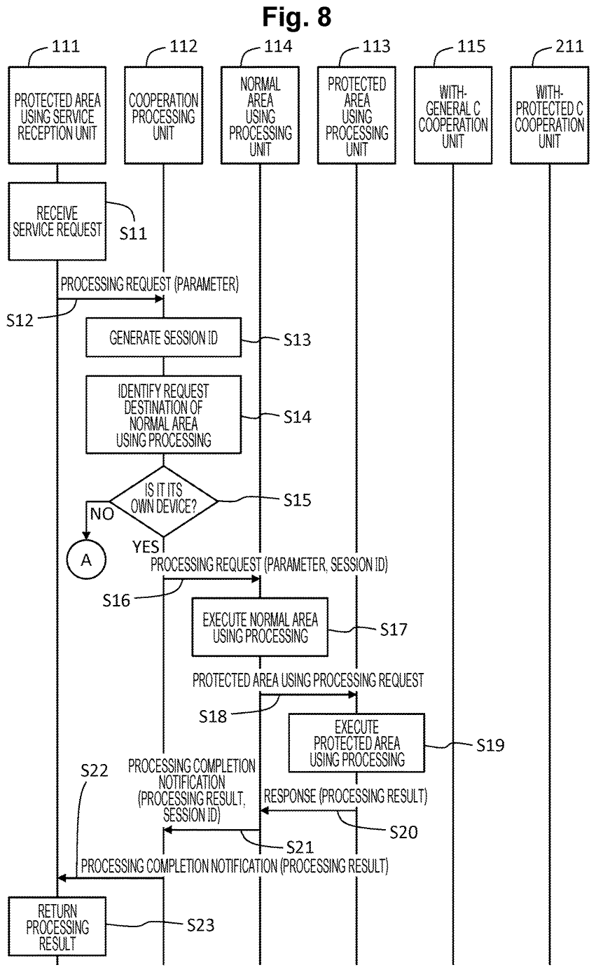

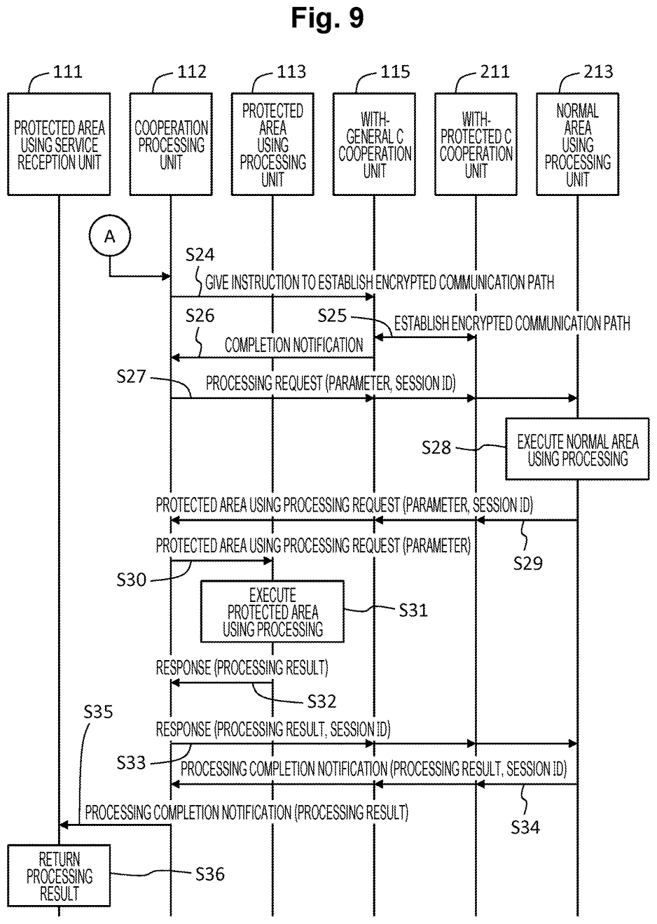

The storage unit 120 includes storage devices such as a read only memory (ROM), a random access memory (RAM), or a solid state drive (SSD). The storage unit 120 includes a memory status database 130 (see FIG. 3 to be described below), memory use amount prediction data 140 (see FIG. 4 to be described below), a general computer database 150 (see FIG. 5 to be described below), a service processing management database 160 (see FIG. 6 to be described below), a protected area 121, a normal area 122, and a program 128. The program 128 includes a description of a processing procedure of the protected area usable computer 100 in cooperation processing (see FIGS. 8 and 9 to be described below). Note that the description of the processing procedure includes data, and the data stored in the protected area 121 and the description of the processing procedure may be encrypted.

The protected area 121 is an area on a main storage (memory) of the protected area usable computer 100, and is an area that can protect data in use and is used only by specific permitted calculation processing (for example, function, module). In the protected area 121, programs and data of permitted calculation processing are stored. The protected area 121 is encrypted, for example, and cannot be accessed even by the OS.

The normal area 122 is an area on the main storage that is not the protected area 121. In the normal area 122, programs and data of calculation processing other than the above-described permitted calculation processing are stored.

### Storage Unit: Memory Status Database

FIG. 3 is a data configuration diagram of the memory status database 130 according to the first embodiment. The memory status database 130 is, for example, tabular data, and one row (record) indicates a free space status (free space capacity, remaining capacity) of a main storage of the protected area usable computer 100 itself or a general computer 200. The record includes columns (attributes) of computer, protected area remaining capacity, normal area remaining capacity, and update date and time.

In the attribute of computer, identification information of the protected area usable computer 100 or a general computer 200 is stored. Note that, in this specification, an IP address is used as the identification information, but the identification information is not limited thereto.

The free space capacity of the protected area 121 is stored in the attribute of protected area remaining capacity, and the free space capacity of the normal area 122 is stored in the attribute of normal area remaining capacity. In the attribute of update date and time, the update date and time of the record are stored. Note that, in FIG. 3, the attribute of update date and time does not include the update date and describes only the update time.

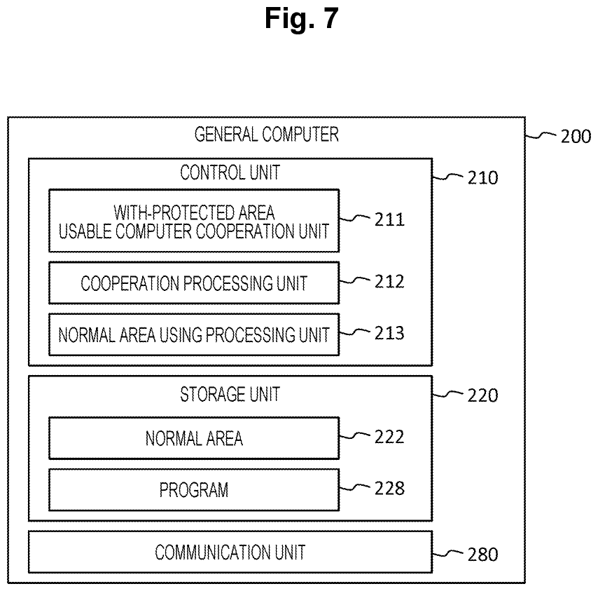

As for the record in the first row in FIG. 3, “127.0.0.1” in the attribute of computer indicates the protected area usable computer 100 itself, the free space capacity (remaining capacity) of the protected area 121 is 8 GB, and the free space capacity of the normal area 122 is 24 GB. The other records indicate the free space capacity of the general computers 200. Since the general computers 200 do not include the protected area 121, the remaining capacity of the protected area is 0, and the remaining capacity of the normal area indicates the free space capacity of a normal area 222 (see FIG. 7 to be described below).

### Storage Unit: Memory Use Amount Prediction Data

FIG. 4 is a data configuration diagram of the memory use amount prediction data 140 according to the first embodiment. The memory use amount prediction data 140 is, for example, tabular data, and one row (record) indicates a formula for calculating (procedure for calculating) the capacity of the protected area 121 and the normal area 122 necessary for processing of a service. The record includes columns (attributes) of service, protected area use amount, and normal area use amount, and stores identification information of the service, a calculation formula of the use amount of the protected area 121 used by the service, and a calculation formula of the use amount of the normal area 122 used by the service, respectively. The unit of the use amount is, for example, MB.

For example, in a case where there is a request for a service B having an input character string length of 100, 51,200 MB of the protected area 121 and 100,000 MB of the normal area 122 are used for processing of this request.

### Storage Unit: General Computer Database

FIG. 5 is a data configuration diagram of the general computer database 150 according to the first embodiment. The general computer database 150 is, for example, tabular data, and one row (record) includes information related to a general computer 200. The record includes columns (attributes) of computer, normal area remaining capacity acquisition interface, normal area using processing, and normal area using processing interface. Note that, in FIG. 5, an interface is referred to as “I/F” (interface).

In the attribute of computer, identification information of a general computer 200 is stored. In the attribute of normal area remaining capacity acquisition interface, information indicating an interface (application programming interface (API)) for acquiring the free space capacity of the normal area 222 (see FIG. 7 to be described below) is stored. In the attribute of normal area using processing, identification information of processing using the normal area 222 executed by the general computer 200 is stored. In the attribute of normal area using processing interface, information indicating an interface (API) that gives a commission of (makes a request for) the processing.

### Storage Unit: Service Processing Management Database

FIG. 6 is a data configuration diagram of the service processing management database 160 according to the first embodiment. The service processing management database 160 is, for example, tabular data, and one row (record) includes information related to processing of a requested service. The record includes columns (attributes) of user, service, cooperation destination, session, and update date and time.

In the attribute of user, identification information of a user who has requested the service or a user terminal 510 (see FIG. 1) is stored. In the attribute of service, identification information of the requested service is stored. In the attribute of cooperation destination, identification information of a general computer 200 is stored in a case where a request for processing using the normal area is made to the general computer 200 in processing of the service. In a case where the protected area usable computer 100 itself executes processing using the normal area, the cooperation destination is “127.0.0.1”. In the attribute of session, identification information for identifying the processing using a normal area for which a request has been made (session identification information) is stored. In the attribute of update date and time, the date and time when the record is updated are stored. Note that, in FIG. 6, the attribute of update date and time does not include the update date and only the update time is described.

### Control Unit: Protected Area Using Service Reception Unit

Returning to FIG. 2, the control unit 110 will be described. The control unit 110 includes a CPU, and includes a protected area using service reception unit 111, a cooperation processing unit 112, a protected area using processing unit 113, a normal area using processing unit 114, and a with-general computer cooperation unit 115.

The protected area using service reception unit 111 receives a request for a service using a protected area 121 from a user terminal 510.

### Control Unit: Cooperation Processing Unit

The cooperation processing unit 112 distributes a series of processing (calculation processing) included in a service for which a request has been received to the protected area using processing unit 113, the normal area using processing unit 114, and the general computer 200 to be described below. More specifically, the cooperation processing unit 112 makes a request for (gives a commission of) processing using the protected area 121 (protected area using processing) in the series of processing to the protected area using processing unit 113. Furthermore, the cooperation processing unit 112 makes a request for (gives a commission of) processing using the normal area 122 but not using the protected area (normal area using processing) to the normal area using processing unit 114 or the general computer 200.

The cooperation processing unit 112 calculates the use amount of the normal area 122 using a calculation formula indicated in the normal area use amount of the memory use amount prediction data 140 (see FIG. 4) on the basis of an input (parameter) included in the request for the service. If there is a free space in the normal area 122 equal to or more than the use amount (see the normal area remaining capacity in the memory status database 130 (see FIG. 3) ), the cooperation processing unit 112 makes a request for the normal area using processing to the normal area using processing unit 114. If there is no free space, the cooperation processing unit 112 makes a request for the normal area using processing to a general computer 200 including a free space.

Furthermore, the cooperation processing unit 112 updates the memory status database 130 at a predetermined timing (for example, periodically). More specifically, the cooperation processing unit 112 acquires the free space capacity of the protected area 121 and the normal area 122 of the protected area usable computer 100 itself and updates its own record (record in which the computer is “127.0.0.1”) in the memory status database 130.

Furthermore, the cooperation processing unit 112 acquires the free space capacity of a normal area 222 (see FIG. 7 described below) of a general computer 200 via an interface indicated in the normal area remaining capacity acquisition interface of the general computer database 150 (see FIG. 5), and stores the free space capacity in the attribute of normal area remaining capacity of the general computer 200.

### Control Unit: Protected Area Using Processing Unit, Normal Area Using Processing Unit, and With-General Computer Cooperation Unit

The protected area using processing unit 113 executes protected area using processing using the protected area 121. The normal area using processing unit 114 executes normal area using processing using the normal area 122. The with-general computer cooperation unit 115 mediates a request for normal area using processing to a general computer 200, a request for protected area using processing from a general computer 200 to the protected area usable computer 100, and a notification (response) of a processing result. Note that the with-general computer cooperation unit 115 establishes a safe communication path between the protected area usable computer 100 and a general computer 200 in cooperation with a with-protected area usable computer cooperation unit 211 (see FIG. 7) to be described below, and then mediates a request for normal area using processing, a request for protected area using processing from the general computer 200 to the protected area usable computer 100, and a notification of a processing result.

### Configuration of General Computer

FIG. 7 is a functional block diagram of a general computer 200 according to the first embodiment. The general computer 200 includes a control unit 210, a storage unit 220, and a communication unit 280. The communication unit 280 includes a communication device, and transmits and receives communication data to and from the protected area usable computers 100.

### General Computer: Storage Unit

The storage unit 220 includes a normal area 222 and a program 228. The program 228 includes a description of a processing procedure of the general computer 200 in the cooperation processing (see FIGS. 8 and 9 to be described below). The normal area 222 is an area on a main storage for executing normal area using processing in response to a request from a protected area usable computer 100. Note that the storage unit 220 of the general computer 200 may include a protected area, but in the present specification, it is assumed that the protected area is not included or used.

### General Computer: Control Unit

The control unit 210 includes a CPU, and includes the with-protected area usable computer cooperation unit 211, a cooperation processing unit 212, and a normal area using processing unit 213.

The with-protected area usable computer cooperation unit 211 mediates a request for normal area using processing from a protected area usable computer 100, a request for protected area using processing from the general computer 200 itself to a protected area usable computer 100, and a notification (response) of a processing result.

Furthermore, the with-protected area usable computer cooperation unit 211 establishes a safe communication path between a protected area usable computer 100 and the general computer 200 in cooperation with the with-general computer cooperation unit 115 (see FIG. 2), and then mediates a request for normal area using processing, a request for protected area using processing from the general computer 200 to the protected area usable computer 100, and a notification of a processing result. Moreover, the with-protected area usable computer cooperation unit 211 responds to an inquiry about the free space capacity (unused storage area capacity) of the normal area 222.

The cooperation processing unit 212 receives a request for normal area using processing from a protected area usable computer 100, and makes a request for the normal area using processing to the normal area using processing unit 213 to be described below. The normal area using processing unit 213 executes the normal area using processing for which the request has been made using the normal area 222.

### Cooperation Processing

FIG. 8 is a first flowchart of the cooperation processing according to the first embodiment. FIG. 9 is a second flowchart of the cooperation processing according to the first embodiment. With reference to FIGS. 8 and 9, processing in which a protected area usable computer 100 and a general computer 200 provide a service in cooperation with each other will be described. Note that, in the drawings referred to below including FIGS. 8 and 9, the with-general computer cooperation unit 115 and the with-protected area usable computer cooperation unit 211 are also referred to as “with-general C cooperation unit” and “with-protected C cooperation unit”, respectively. The session identification information is also referred to as “session ID”.

In step S11, the protected area using service reception unit 111 receives a service request from a user terminal 510.

In step S12, the protected area using service reception unit 111 makes a request for processing of the requested service to the cooperation processing unit 112. This request includes a parameter (input parameter) transmitted from the user terminal 510 and identification information of the user who uses the user terminal 510 that has made a request for the service.

In step S13, the cooperation processing unit 112 generates session identification information. The generated session identification information is stored in the service processing management database 160 (see FIG. 6) together with the identification information of the user and the like.

In step S14, the cooperation processing unit 112 identifies a request destination of normal area using processing. More specifically, the cooperation processing unit 112 calculates the capacity (use amount) of the normal area 122 to be used on the basis of the parameter included in the request in step S12 (see the normal area use amount of the memory use amount prediction data 140 illustrated in FIG. 4). Next, if there is a free space equal to or more than the use amount (see the normal area remaining capacity of the memory status database 130 illustrated in FIG. 3) in the normal area 122 of the protected area usable computer 100 that is its own device, the cooperation processing unit 112 sets the normal area using processing unit 114 as the request destination. If there is no free space in the normal area 122, the cooperation processing unit 112 sets a general computer 200 including a free space equal to or more than the use amount (see the normal area remaining capacity in the memory status database 130 illustrated in FIG. 3) in the normal area 222 as the request destination. The cooperation processing unit 112 stores the request destination in the attribute of cooperation destination of the service processing management database 160 (see FIG. 6).

In step S15, the cooperation processing unit 112 proceeds to step S16 in a case where the identified request destination is its own device (normal area using processing unit 114) (step S15→YES), and proceeds to step S24 described in FIG. 9 in a case where the identified request destination is not its own device (step S15→NO).

In step S16, the cooperation processing unit 112 makes a request for processing of the requested service to the normal area using processing unit 114. This request includes the parameter transmitted from the user terminal 510 and the session identification information generated in step S13.

In step S17, the normal area using processing unit 114 executes the normal area using processing.

In step S18, in a case where the normal area using processing is shifted to protected area using processing, the normal area using processing unit 114 makes a request for (gives a commission of) the protected area using processing to the protected area using processing unit 113. The request (commission) includes a parameter necessary for the protected area using processing.

In step S19, the protected area using processing unit 113 executes the protected area using processing for which the request has been made (of which the commission has been given).

In step S20, the protected area using processing unit 113 returns a response including a processing result of the protected area using processing to the normal area using processing unit 114. Note that steps S17 to S20 may be repeatedly executed.

In step S21, in a case where the normal area using processing is finished, the normal area using processing unit 114 returns a processing completion notification including the processing result and the session identification information to the cooperation processing unit 112.

In step S22, the cooperation processing unit 112 returns the processing completion notification including the processing result to the protected area using service reception unit 111.

In step S23, the protected area using service reception unit 111 returns the processing result to the user terminal 510.

Referring now to FIG. 9, processing in a case where a request for the normal area using processing is made to a general computer 200 (step S15→NO) will be described.

In step S24, the cooperation processing unit 112 instructs the with-general computer cooperation unit 115 to establish an encrypted communication path between its own device (protected area usable computer 100) and the general computer 200 as the request destination. This instruction includes identification information of the general computer 200 as the request destination identified in step S14.

In step S25, the with-general computer cooperation unit 115 establishes an encrypted communication path in cooperation with the with-protected area usable computer cooperation unit 211 of the general computer 200 as the request destination. Data exchanged between the protected area usable computer 100 and the general computer 200 subsequently is transmitted and received through this encrypted communication path.

In step S26, the with-general computer cooperation unit 115 returns a completion notification of the establishment of the encrypted communication path to the cooperation processing unit 112.

In step S27, the cooperation processing unit 112 makes a request for processing of the requested service to the general computer 200 via the with-general computer cooperation unit 115. This request includes the parameter transmitted from the user terminal 510 and the session identification information generated in step S13. This request is transferred from the with-general computer cooperation unit 115 to the with-protected area usable computer cooperation unit 211 of the general computer 200, and further to the cooperation processing unit 212 (not illustrated in FIG. 9, see FIG. 7) and the normal area using processing unit 213.

In step S28, the normal area using processing unit 213 executes the normal area using processing.

In step S29, in a case where the normal area using processing is shifted to protected area using processing, the normal area using processing unit 213 requests (commissions) the protected area usable computer 100 to execute the protected area using processing. The request is transmitted to the cooperation processing unit 212 in a direction opposite to that of the processing request (see step S27), and is further transferred to the with-protected area usable computer cooperation unit 211, the with-general computer cooperation unit 115 of the protected area usable computer 100, and the cooperation processing unit 112. The request includes a parameter necessary for the protected area using processing and the session identification information.

In step S30, the cooperation processing unit 112 makes a request (gives a commission of) execution of the protected area using processing to the protected area using processing unit 113. The request includes a parameter necessary for the protected area using processing.

In step S31, the protected area using processing unit 113 executes the protected area using processing for which the request has been made.

In step S32, the protected area using processing unit 113 returns a response including a processing result of the protected area using processing to the cooperation processing unit 112.

In step S33, the cooperation processing unit 112 returns the processing result of the protected area using processing including the session identification information to the normal area using processing unit 213. Note that steps S28 to S33 may be repeatedly executed.

In step S34, in a case where the normal area using processing is finished, the normal area using processing unit 213 returns a processing completion notification including the processing result and the session identification information to the cooperation processing unit 112.

Steps S35 to S36 are similar to steps S22 to S23.

### Features of Cooperation Processing

The protected area usable computer 100 executes processing by itself in a case where there is a free space in the normal area 122 necessary for processing of a service. In a case where there is no free space in the normal area 122, the protected area usable computer 100 executes processing using the protected area 121 by itself, and makes a request for processing using the normal area to a general computer 200.

By adopting such a processing mode, a service can be provided even in a case where there is no sufficient free space in the normal area 122 in the protected area usable computer 100. That is, efficient use of a memory in processing of providing a service using a protected area is enabled.

Data stored in a protected area is highly confidential data such as an encryption key and authentication information, and protected area using processing is considered to be processing related to such data. The proportion occupied by protected area using processing in the entire processing of executing a service is generally low, and most of the processing is assumed to be normal area using processing. In the cooperation processing system 10, in a case where there is a free space in the normal area 122 of the protected area usable computer 100, processing of a service is completed in its own device, and the processing can be executed at high speed. In a case where there is no free space in the normal area 122, most of the processing can be executed by an existing general computer 200, and efficient service processing can be executed.

### Modification: Sharing of Encrypted Communication Path

In the embodiment described above, an encrypted communication path is established each time a request for normal area using processing is made to a general computer 200 (steps S24 to S26). In a case where a request for normal area using processing related to a plurality of services (requests for services) is made to the same general computer 200, a processing request/response of normal area using processing/protected area using processing may be made via the same encrypted communication path. The processing request/response of the normal area using processing and the protected area using processing (see steps S27, S29, S33, and S34) includes session identification information, and which normal area using processing/protected area using processing relates to which service request processing can be identified. As a result, the loads of processing related to establishment of an encrypted communication path can be reduced.

### Second Embodiment

In the first embodiment described above, the protected area usable computer 100 responds to a user terminal 510 after processing of a service is completed (see steps S22 and S23 in FIG. 8 and steps S35 and S36 in FIG. 9). On the other hand, a protected area usable computer 100A (not illustrated) included in a cooperation processing system 10A (not illustrated) according to a second embodiment returns a response without waiting for the end of processing. After receiving the response, a user terminal 510 requests and acquires a processing result from the protected area usable computer 100A. Hereinafter, differences from the first embodiment will be described.

### Second Embodiment: Service Processing Management Database

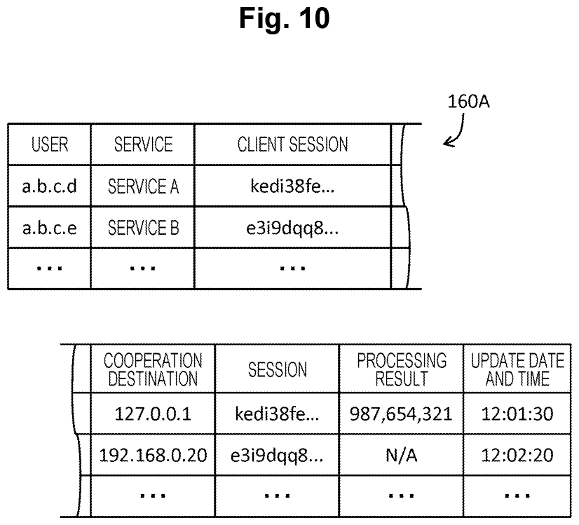

FIG. 10 is a data configuration diagram of a service processing management database 160A according to the second embodiment. Attributes of client session and processing result are added in comparison with the service processing management database 160 (see FIG. 6) of the first embodiment. In the attribute of client session, session identification information (hereinafter, described as client session identification information) transmitted to a user terminal 510 in response to a request for a service is stored. In the attribute of processing result, a processing result of the requested service is stored. The processing result “N/A” is an abbreviation of Not Applicable and indicates that the processing is in progress and a processing result has not been obtained.

### Second Embodiment: Cooperation Processing

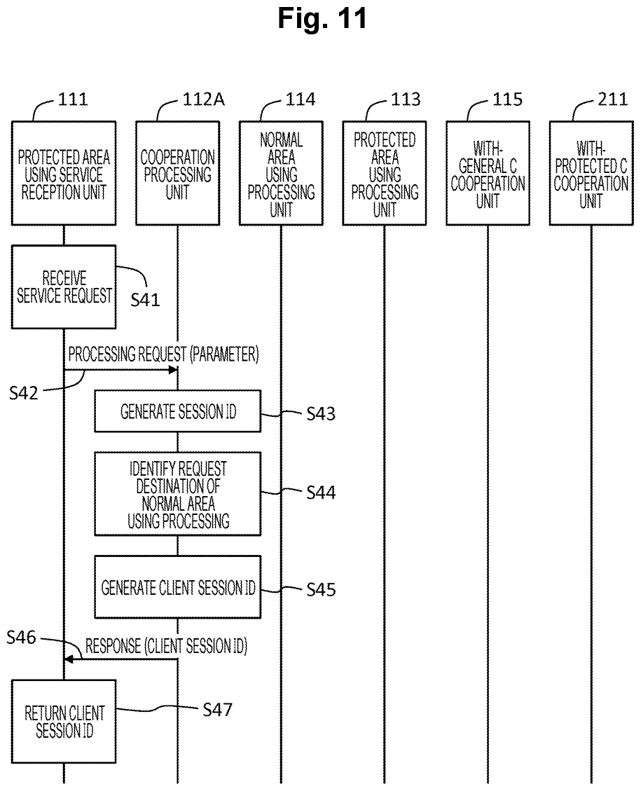

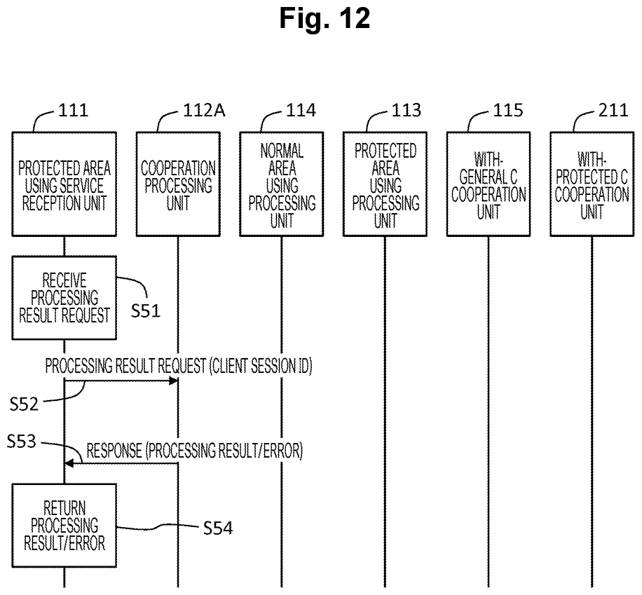

FIG. 11 is a first sequence diagram for describing cooperation processing according to the second embodiment. FIG. 12 is a second sequence diagram for describing the cooperation processing according to the second embodiment. Differences from the cooperation processing according to the first embodiment (see FIGS. 8 and 9) will be described with reference to FIGS. 11 and 12.

Steps S41 to S44 are similar to steps S11 to S14 (see FIG. 8).

In step S45, a cooperation processing unit 112A generates client session identification information and stores the client session identification information in a service processing management database 160A (see FIG. 10).

In step S46, the cooperation processing unit 112A returns a response including the client session identification information to a protected area using service reception unit 111.

In step S47, the protected area using service reception unit 111 returns a response including the client session identification information to a user terminal 510.

Hereinafter, processing after step S15 until the cooperation processing unit 112A receives a processing completion notification (see step S21 in FIG. 8 and step S34 in FIG. 9) is similar to that of the first embodiment. Upon receiving the processing completion notification, the cooperation processing unit 112A stores a processing result included in the processing completion notification in the attribute of processing result of the service processing management database 160A (see FIG. 10). The cooperation processing unit 112A does not perform notification of processing completion (see steps S22 and S35) to the protected area using service reception unit 111, and the protected area using service reception unit 111 does not perform transmission of the processing result (see steps S23 and S36) to the user terminal 510.

Referring now to FIG. 12, the description of the cooperation processing is continued.

In step S51, it is assumed that the protected area using service reception unit 111 receives a processing result request including the client session identification information (see step S47) from the user terminal 510.

In step S52, the protected area using service reception unit 111 requests a processing result from the cooperation processing unit 112. The request includes the client session identification information.

In step S53, the cooperation processing unit 112A acquires a processing result corresponding to the client session identification information with reference to the service processing management database 160A (see FIG. 10), and returns a response including the processing result. Note that, in a case where there is no processing result (“N/A”), the cooperation processing unit 112 returns an error indicating that the processing is in progress.

In step S54, the protected area using service reception unit 111 returns the processing result or the error to the user terminal 510.

### Features of Second Embodiment

The user terminal 510 using the cooperation processing system 10 according to the first embodiment needs to wait until a processing result of a service is obtained after requesting the service. On the other hand, the user terminal 510 according to the second embodiment can request and acquire a processing result at a point of time when the processing result is necessary (see step S51 described in FIG. 12) after making a request for a service to the cooperation processing system 10A (see step S47 described in FIG. 11).

### Third Embodiment

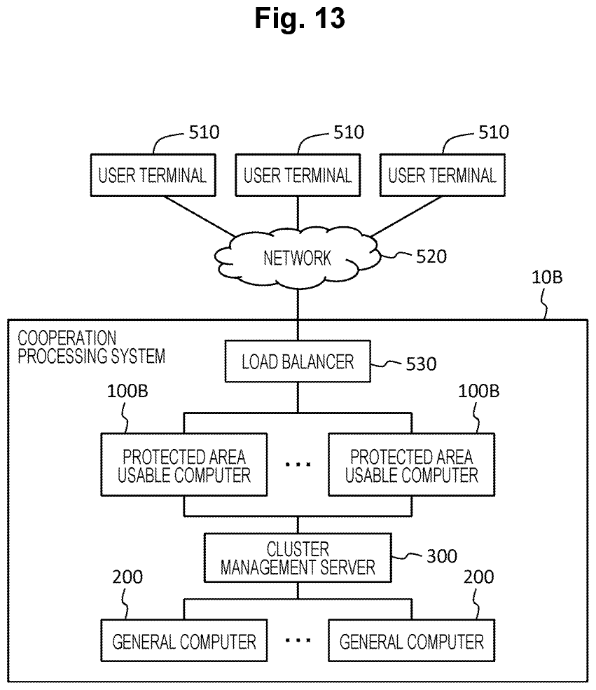

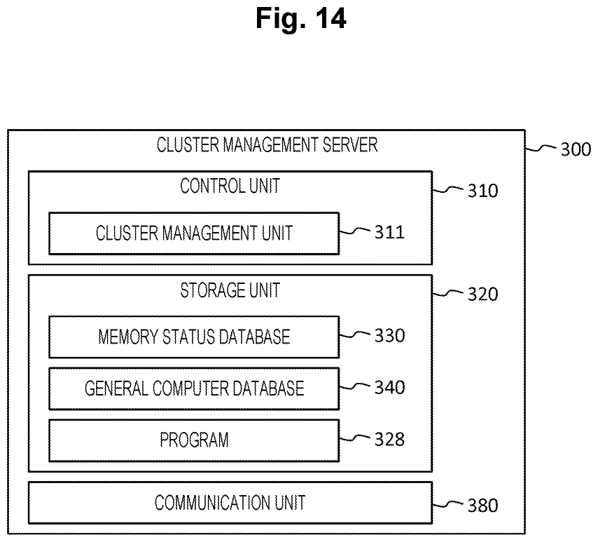

The protected area usable computer 100 according to the first embodiment grasps the free space capacity of normal areas 222 of general computers 200 (see the memory status database 130 illustrated in FIG. 3), and the cooperation processing unit 112 identifies a general computer 200 to which a request for normal area using processing is made (see step S14 illustrated in FIG. 8). A cluster management server 300 (see FIGS. 13 and 14 to be described below) may grasp the free space capacity of the normal areas 222 of the general computers 200, and a protected area usable computer 100B may inquire of the cluster management server about a general computer 200 to which a request for normal area using processing is made.

### Third Embodiment: Configuration of Cooperation Processing System

FIG. 13 is an overall configuration diagram of a cooperation processing system 10B according to the third embodiment. As compared with the cooperation processing system 10 according to the first embodiment, the cluster management server 300 is added between the layer of protected area usable computers 100B and the layer of general computers 200.

The protected area usable computer 100B according to the third embodiment is different from the protected area usable computer 100 according to the first embodiment in the cooperation processing unit 112B. The cooperation processing unit 112 according to the first embodiment identifies a general computer 200 to which a request for normal area using processing is made with reference to the memory status database 130 (see FIG. 3) in a case where there is no free space in the normal area 122 in itself (see step S14 in FIG. 8). On the other hand, the cooperation processing unit 112B inquires of the cluster management server 300 and identifies a general computer 200 to which a request for normal area using processing is made in a case where there is no free space in the normal area 122 in itself.

### Third Embodiment: Configuration of Cluster Management Server

FIG. 14 is a functional block diagram of the cluster management server 300 according to the third embodiment. The cluster management server 300 is a computer, and includes a control unit 310, a storage unit 320, and a communication unit 380. The communication unit 380 includes a communication device, and transmits and receives communication data to and from the protected area usable computer 100B and the general computers 200.

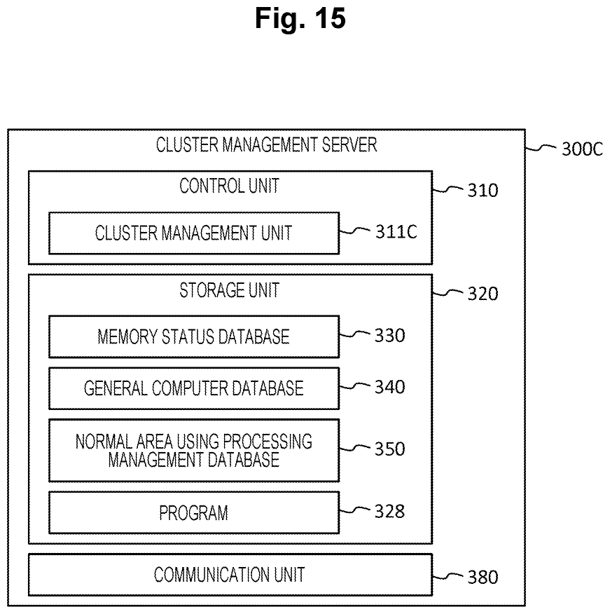

The storage unit 320 includes storage devices such as a ROM, a RAM, and an SSD. The storage unit 320 stores a memory status database 330, a general computer database 340, and a program 328. The memory status database 330 and the general computer database 340 have data configurations similar to those of the memory status database 130 (see FIG. 3) and the general computer database 150 (see FIG. 5) included in the protected area usable computer 100, respectively. The program 328 includes a description of a procedure related to processing of the cluster management server 300 in cooperation processing (see FIG. 15) to be described below.

The control unit 310 includes a CPU and includes a cluster management unit 311. Similarly to the cooperation processing unit 112, the cluster management unit 311 updates the memory status database 330 at a predetermined timing (for example, periodically). Furthermore, the cluster management unit 311 responds to an inquiry including the size of a normal area to be used from a protected area usable computer 100B with identification information of a general computer 200 including free space capacity of the size.

### Features of Third Embodiment

In the first embodiment, each of the protected area usable computers 100 inquires of each of the general computers 200 about the free space capacity of the normal area 222. On the other hand, in the third embodiment, the cluster management server 300 inquires about the free space capacity, and thus loads of the protected area usable computers 100 and the general computers 200 are reduced.

### Fourth Embodiment

In the third embodiment, the cluster management server 300 mediates an inquiry about the free space capacity of the normal areas 222 of the general computers 200. A protected area usable computer 100C (not illustrated) according to a cooperation processing system 10C (not illustrated) according to a fourth embodiment makes a request for normal area using processing to a general computer 200 via a cluster management server 300C (see FIG. 15 to be described below).

### Fourth Embodiment: Cluster Management Server

FIG. 15 is a functional block diagram of the cluster management server 300C according to the fourth embodiment. As compared with the cluster management server 300 according to the third embodiment, a normal area using processing management database 350 is added to a storage unit 320, and a cluster management unit 311C is different.

Upon receiving a request for normal area using processing including the use amount of a normal area 222, the cluster management unit 311C identifies a general computer 200 including a free space of the use amount (see a memory status database 330), and makes a request for the normal area using processing.

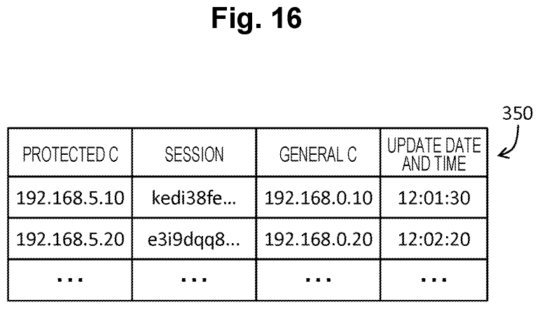

FIG. 16 is a data configuration diagram of the normal area using processing management database 350 according to the fourth embodiment. The normal area using processing management database 350 is, for example, tabular data, and one row (record) indicates one piece of normal area using processing. The record includes columns (attributes) of protected area usable computer (described as “protected C” in FIG. 16), session, general computer (described as “general C” in FIG. 16), and update date and time.

In the attribute of protected area usable computer, identification information of a protected area usable computer 100C that has made a request for normal area using processing is stored. In the attribute of session, session identification information related to the normal area using processing is stored. In the attribute of general computer, identification information of a general computer 200 as a request destination of the normal area using processing is stored. In the attribute of update date and time, the update date and time of the record are stored. Note that, in FIG. 16, the update date and time does not include the update date and only the update time is stored.

### Fourth Embodiment: Cooperation Processing

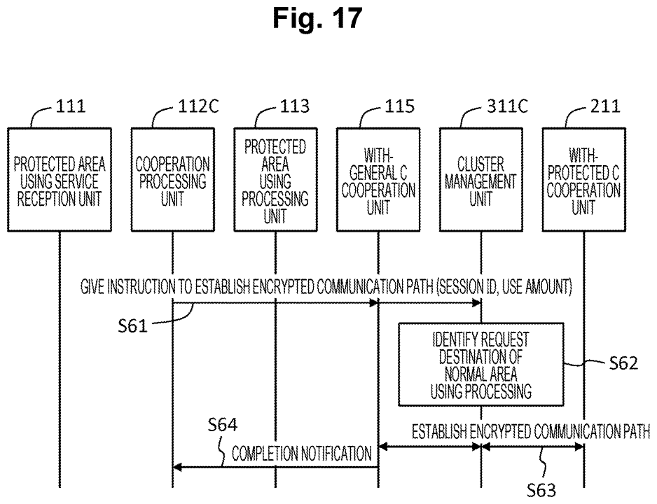

FIG. 17 is a sequence diagram for describing cooperation processing according to the fourth embodiment. With reference to FIG. 17, differences from the first embodiment in processing in a case where a request for normal area using processing is made to a general computer 200 (see FIG. 9) according to the fourth embodiment will be described. Note that, in step S14 (see FIG. 8) of the first embodiment, the cooperation processing unit 112 identifies a general computer 200 to which a request for normal area using processing is made, but identification is not performed in the fourth embodiment. More specifically, in a case where there is no free space in its own normal area 122 (see step S15→NO), a cooperation processing unit 112C proceeds to the processing of FIG. 17.

In step S61, the cooperation processing unit 112C instructs a with-general computer cooperation unit 115 to establish an encrypted communication path between its own device (protected area usable computer 100C) and the cluster management server 300C. This instruction includes session identification information generated in step S13 and the use amount of a normal area 222 necessary for normal area using processing for which a request is made calculated in step S14. The with-general computer cooperation unit 115 transmits this instruction content to the cluster management server 300C.

In step S62, the cluster management unit 311C identifies a general computer 200 including a free space equal to or more than the use amount in the normal area 222 and is a request destination of the normal area using processing with reference to the memory status database 330.

In step S63, the with-general computer cooperation unit 115, the cluster management unit 311C, and the with-protected area usable computer cooperation unit 211 of the general computer 200 as the request destination establish an encrypted communication path in cooperation with each other.

In step S64, the with-general computer cooperation unit 115 returns a completion notification of the establishment of the encrypted communication path to the cooperation processing unit 112C.

Subsequent processing is similar to that in the first embodiment (steps S27 to S36 in FIG. 9). However, a processing request/response of normal area using processing and protected area using processing is made via the with-general computer cooperation unit 115, the cluster management unit 311C, the with-protected area usable computer cooperation unit 211 (see FIGS. 7 and 9), and a cooperation processing unit 212. In other words, the cooperation processing unit 112C makes a request for the normal area using processing to the cluster management server 300C, and the cluster management unit 311C makes a request for the normal area using processing to the general computer 200.

### Features of Fourth Embodiment

As compared with the first embodiment, in the protected area usable computer 100C of the fourth embodiment, the cluster management server 300C executes processing of making a request for normal area using processing to a general computer 200, and the processing loads are reduced.

### Modification: Sharing of Encrypted Communication Path

In the fourth embodiment described above, an encrypted communication path between a protected area usable computer 100 and the cluster management server 300C and an encrypted communication path between the cluster management server 300C and a general computer 200 establish an encrypted communication path each time a request for normal area using processing is made to a general computer 200 (see steps S61 to S64 in FIG. 17). The cluster management server 300C may have one encrypted communication path with each of the protected area usable computer 100 and the general computer 200.

### Other Modifications

Although some embodiments of the present invention have been described above, these embodiments are merely examples and do not limit the technical scope of the present invention. For example, the normal area using processing unit 114 directly makes a request for protected area using processing to the protected area using processing unit 113, but may make a request via the cooperation processing unit 112.

For example, in the above embodiments, the protected area usable computer 100, 100A, 100B, 100C first receives processing of a request for a service, but a general computer 200 may receive the processing of a request for a service. A request for protected area using processing may be made to the protected area usable computer 100, 100A, 100B, 100C at the time of normal area using processing shifting to protected area using processing.

The present invention can take various other embodiments, and various modifications such as omissions and substitutions can be made without departing from the gist of the present invention. These embodiments and modifications thereof are included in the scope and gist of the invention described in the present specification and the like, and are included in the invention described in the claims and the equivalent scope thereof.

### Hardware Configuration

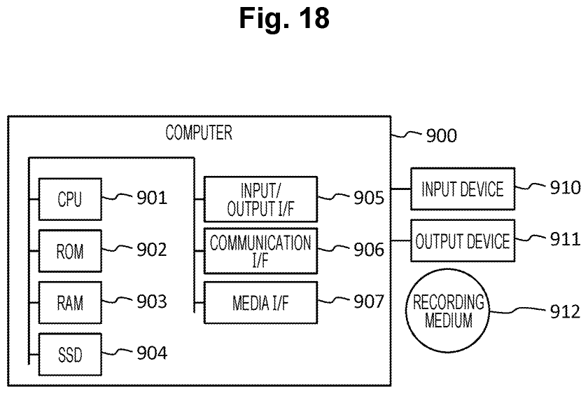

The protected area usable computer 100 according to the above-described embodiment is implemented by, for example, a computer 900 having a configuration as illustrated in FIG. 18. FIG. 18 is a hardware configuration diagram illustrating an example of the computer 900 that implements functions of the protected area usable computer 100, 100A, 100B, 100C according to the above-described embodiments. The computer 900 includes a CPU 901, a ROM 902, a RAM 903, an SSD 904, an input/output interface 905 (described as an input/output I/F in FIG. 18), a communication interface 906 (described as a communication I/F in FIG. 18), and a media interface 907 (described as a media I/F in FIG. 18). The computer 900 may include a hard disc drive (HDD) instead of the SSD 904, or may further include an HDD in addition to the SSD 904.

The CPU 901 operates on the basis of a program stored in the ROM 902 or the SSD 904, and performs control by the control unit 110 illustrated in FIG. 2. The ROM 902 stores a boot program executed by the CPU 901 when the computer 900 is activated, a program related to hardware of the computer 900, and the like.

The CPU 901 controls an input device 910 such as a mouse and a keyboard and an output device 911 such as a display and a printer via the input/output interface 905. The CPU 901 acquires data from the input device 910 and outputs generated data to the output device 911 via the input/output interface 905.

The SSD 904 stores a program to be executed by the CPU 901, data to be used by the program, and the like. The communication interface 906 receives data from another device (for example, load balancer 530 or general computer 200) not illustrated via a communication network and outputs the data to the CPU 901, and transmits data generated by the CPU 901 to another device via a communication network.

The media interface 907 reads a program or data stored in a recording medium 912 and outputs the program or data to the CPU 901 via the RAM 903. The CPU 901 loads the program from the recording medium 912 into the RAM 903 via the media interface 907, and executes the loaded program. The recording medium 912 is an optical recording medium such as a digital versatile disk (DVD), a magneto-optical recording medium such as a magneto optical disk (MO), a magnetic recording medium, a conductor memory tape medium, a semiconductor memory, or the like.

For example, in a case where the computer 900 functions as the protected area usable computer 100 according to the above-described embodiment, the CPU 901 of the computer 900 implements the function of the protected area usable computer 100 by executing the program 128 (see FIG. 2) loaded on the RAM 903. The CPU 901 reads the program from the recording medium 912 and executes the program. In addition, the CPU 901 may read the program from another device via a communication network, or may install the program 128 from the recording medium 912 to the SSD 904 and execute the program.

### Effects

Effects of the device will be described below.

A cooperation processing system 10 is a cooperation processing system 10 that includes a protected area usable computer 100 and a general computer 200.

The protected area usable computer 100 includes a storage unit 120 that includes a protected area 121 capable of protecting data in use and a normal area 122 different from the protected area 121.

The protected area usable computer 100 includes a protected area using processing unit 113 that executes protected area using processing processed in the protected area 121, a normal area using processing unit 114 that executes normal area using processing processed in the normal area 122, a service reception unit (protected area using service reception unit 111) that receives a request for a service, and a cooperation processing unit (see cooperation processing unit 112, with-general computer cooperation unit 115) that makes a request for processing of the service to the normal area using processing unit 114 or the general computer 200.

The general computer 200 includes a cooperation unit (see with-protected area usable computer cooperation unit 211, cooperation processing unit 212, normal area using processing unit 213) that receives a request for processing of the service, executes normal area using processing in processing included in processing of the service, and returns a processing result.

The normal area using processing unit 114 makes a request to the protected area using processing unit 113 and causes the protected area using processing unit 113 to execute the protected area using processing in a case where the protected area using processing is included in processing included in processing of the service.

The cooperation unit makes a request to the cooperation processing unit and causes the protected area using processing unit 113 to execute the protected area using processing in a case where the protected area using processing is included in processing included in processing of the service.

According to such a cooperation processing system 10, the service can be provided even in a case where there is no sufficient free space in the normal area 122 in the protected area usable computer 100.

The cooperation processing unit calculates a normal area use amount that is capacity of a normal area necessary for processing of the service, and makes a request for the normal area using processing to the normal area using processing unit 114 in a case where unused storage area capacity of the normal area 122 included in the storage unit 120 is equal to or more than the normal area use amount. A request for the normal area using processing is made to the general computer 200 in a case where unused storage area capacity of a normal area included in the storage unit 120 is less than the normal area use amount.

According to such a cooperation processing system 10, the protected area usable computer 100 itself executes normal area using processing in a case where there is a sufficient free space of the normal area 122 in the protected area usable computer 100, so that service processing can be performed at high speed.

The cooperation processing system 10B further includes the cluster management server 300.

A cooperation unit included in the general computer 200 responds to an inquiry about unused storage area capacity with unused storage area capacity of a storage unit 220 included in the general computer 200.

The cluster management server 300 includes the cluster management unit 311 that inquires and acquires unused storage area capacity of the general computer 200, and, in response to an inquiry including a normal area use amount that is capacity of a normal area necessary for processing of the service, returns identification information of a general computer 200 including unused storage area capacity equal to or more than the normal area use amount.

A cooperation processing unit included in the protected area usable computer 100B calculates the normal area use amount, and makes a request for the normal area using processing to the normal area using processing unit 114 the normal area using processing in a case where unused storage area capacity of a normal area included in a storage unit 120 included in the protected area usable computer 100B is equal to or more than the normal area use amount.

The cooperation processing unit included in the protected area usable computer 100B makes an inquiry including the normal area use amount to the cluster management server 300, acquires the identification information, and makes a request for the normal area using processing to a general computer 200 corresponding to the identification information in a case where unused storage area capacity of a normal area 122 included in the storage unit 120 included in the protected area usable computer 100B is less than the normal area use amount.

According to such a cooperation processing system 10B, the cluster management server 300 inquires of the general computer 200 about the free space capacity, and thus loads of the protected area usable computer 100B and the general computer 200 are reduced.

The cooperation processing system 10C further includes the cluster management server 300C.

A cooperation unit included in the general computer 200 responds to an inquiry about unused storage area capacity with unused storage area capacity of a storage unit 220 included in the general computer 200.

The cluster management server 300C includes the cluster management unit 311C that inquires and acquires unused storage area capacity of the general computer 200, and, in response to a request for the normal area using processing including a normal area use amount that is capacity of a normal area 222 necessary for processing of the service, makes a request for the normal area using processing to a general computer 200 including unused storage area capacity equal to or more than the normal area use amount.

A cooperation processing unit included in the protected area usable computer 100C calculates the normal area use amount, and makes a request for the normal area using processing to the normal area using processing unit 114 in a case where unused storage area capacity of a normal area included in a storage unit 120 included in the protected area usable computer 100C is equal to or more than the normal area use amount.

The cooperation processing unit included in the protected area usable computer 100C makes a request for the normal area using processing including the normal area use amount to the cluster management server 300C in a case where unused storage area capacity of a normal area included in the storage unit 120 included in the protected area usable computer 100C is less than the normal area use amount.

According to such a cooperation processing system 10, the protected area usable computer 100C delegates processing of making a request for normal area using processing to the general computer 200 to the cluster management server 300C, and the processing loads are reduced.

The cooperation processing unit of the protected area usable computer 100A, upon receiving a request for processing of the service from the service reception unit (protected area using service reception unit 111), generates session identification information, instructs the service reception unit to transmit the session identification information to a request source of the service (user terminal 510), and makes a request for processing of the service to the normal area using processing unit 114 or the general computer 200, and stores a processing result of the processing in association with the session identification information.

The service reception unit receives a request for a processing result including the session identification information.

The cooperation processing unit, upon receiving a request for processing of the request from the service reception unit, instructs the service reception unit to transmit a processing result corresponding to the session identification information to a request source of the service.

According to such a cooperation processing system 10, a request source of a service can request and acquire a processing result at a point of time when the processing result is necessary (see step S51 described in FIG. 12) after making a request for the service to the cooperation processing system 10A (see step S47 described in FIG. 11).

### REFERENCE SIGNS LIST

10, 10A, 10B, 10C Cooperation processing system
100, 100A, 100B, 100C Protected area usable computer
111 Protected area using service reception unit (service reception unit)
112, 112A, 112B, 112C Cooperation processing unit
113 Protected area using processing unit
114 Normal area using processing unit
115 With-general computer cooperation unit (cooperation processing unit)
120 Storage unit
121 Protected area
122 Normal area
128 Program
200 General computer
211 With-protected area usable computer cooperation unit (cooperation unit)
212 Cooperation processing unit (cooperation unit)
213 Normal area using processing unit (cooperation unit)
300, 300C Cluster management server
311, 311C Cluster management unit

1. A cooperation processing system comprising a protected area usable computer and a general computer,
wherein the protected area usable computer includes:
a storage memory that includes a protected area configured to protect data in use and a normal area different from a corresponding protected area;
a protected area using processing unit configured to execute protected area using processing processed in the protected area;
a normal area using processing unit configured to execute normal area using processing processed in the normal area;
a service reception unit configured to receive a request for a service; and
a cooperation processing unit configured to make a request for processing of the service to the normal area using processing unit or the general computer,
wherein the general computer includes
a cooperation unit configured to receive a request for processing of the service, execute normal area using processing in processing included in processing of a corresponding service, and return a processing result,
the normal area using processing unit is configured to make a request for the protected area using processing unit and cause the protected area using processing unit to execute the protected area using processing in a case where the protected area using processing is included in processing included in processing of the service, and
the cooperation unit is configured to make a request to the cooperation processing unit and cause the protected area using processing unit to execute the protected area using processing in a case where the protected area using processing is included in processing included in processing of the service.

2. The cooperation processing system according to claim 1,
wherein the cooperation processing unit is configured to
calculate a normal area use amount that is capacity of a normal area necessary for processing of the service,
make a request for the normal area using processing to the normal area using processing unit
in a case where unused storage area capacity of a normal area included in the storage memory is equal to or more than the normal area use amount, and
make a request for the normal area using processing to the general computer
in a case where unused storage area capacity of a normal area included in the storage memory is less than the normal area use amount.

3. The cooperation processing system according to claim 1 further comprising
a cluster management server,
wherein a cooperation unit included in the general computer is configured to
respond to an inquiry about unused storage area capacity with unused storage area capacity of a storage memory included in a corresponding general computer,
the cluster management server
includes a cluster management unit configured to inquire about and acquire unused storage area capacity of the general computer, and,
in response to an inquiry including a normal area use amount that is capacity of a normal area necessary for processing of the service, return identification information of the general computer including unused storage area capacity equal to or more than a corresponding normal area use amount, and
a cooperation processing unit included in the protected area usable computer is configured to
calculate the normal area use amount,
make a request for the normal area using processing to the normal area using processing unit
in a case where unused storage area capacity of a normal area included in a storage memory included in the protected area usable computer is equal to or more than the normal area use amount,
make an inquiry including the normal area use amount to the cluster management server, acquires the identification information, and
make a request for the normal area using processing to a general computer corresponding to corresponding identification information
in a case where unused storage area capacity of a normal area included in storage memory included in the protected area usable computer is less than the normal area use amount.

4. The cooperation processing system according to claim 1 further comprising
a cluster management server,
wherein a cooperation unit included in the general computer is configured to
respond to an inquiry about unused storage area capacity with unused storage area capacity of a storage memory included in a corresponding general computer,
the cluster management server
includes a cluster management unit configured to inquire about and acquire unused storage area capacity of the general computer, and,
in response to a request for the normal area using processing including a normal area use amount that is capacity of a normal area necessary for processing of the service, make a request for corresponding normal area using processing to a general computer including unused storage area capacity equal to or more than a corresponding normal area use amount, and
a cooperation processing unit included in the protected area usable computer configured to
calculate the normal area use amount,
make a request for the normal area using processing to the normal area using processing unit
in a case where unused storage area capacity of a normal area included in a storage memory included in the protected area usable computer is equal to or more than the normal area use amount, and
make a request for the normal area using processing including the normal area use amount to the cluster management server
in a case where unused storage area capacity of a normal area included in a storage memory included in the protected area usable computer is less than the normal area use amount.

5. The cooperation processing system according to claim 1,
wherein the cooperation processing unit is configured to,
upon receiving a request for processing of the service from the service reception unit, generate session identification information, instruct the service reception unit to transmit corresponding session identification information to a request source of the service, and
make a request for processing of the service to the normal area using processing unit or the general computer, and store a processing result of corresponding processing in association with corresponding session identification information,
the service reception unit is configured to
receive a request for a processing result including the session identification information, and
the cooperation processing unit is configured to,
upon receiving a request for processing of a corresponding request from the service reception unit, instruct the service reception unit to transmit a processing result corresponding to the session identification information to a request source of the service.

6. A protected area usable computer of a cooperation processing system including a protected area usable computer and a general computer, comprising:
a storage memory that includes a protected area configured to protect data in use and a normal area different from a corresponding protected area;
a protected area using processing unit configured to execute protected area using processing processed in the protected area;
a normal area using processing unit configured to execute normal area using processing processed in the normal area;
a service reception unit configured to receive a request for a service; and
a cooperation processing unit configured to make a request for processing of the service to the normal area using processing unit or the general computer,
the normal area using processing unit is configured to make a request to the protected area using processing unit and cause the protected area using processing unit to execute the protected area using processing in a case where the protected area using processing is included in processing included in processing of the service, and
the cooperation processing unit is configured to, upon receiving the protected area using processing in processing included in processing of the service from the general computer, make a request to the protected area using processing unit, cause the protected area using processing unit to execute corresponding protected area using processing, and return a processing result to the general computer.

7. (canceled)

8. A cooperation processing method of a protected area usable computer of a cooperation processing system including a protected area usable computer and a general computer,
wherein the protected area usable computer
includes a storage unit memory that includes a protected area configured to protect data in use and a normal area different from a corresponding protected area,
receive a request for a service, and
determine whether to execute processing of the service in the protected area usable computer or make a request for processing of the service to the general computer,
executing protected area using processing processed in the protected area in processing included in processing of the service and
executing normal area using processing processed in the normal area in processing included in processing of the service
in a case where processing of the service is executed in the protected area usable computer, and
executing a step of, upon receiving the protected area using processing in processing included in processing of the service from the general computer, executing corresponding protected area using processing
in a case where a request is made to the general computer.
